(19) United States
(12) Patent Application Publication
(10) Pub. No.: US 2024/0075937 A1
(43) Pub. Date: Mar. 7, 2024

(54) TRACTION CONTROL GUIDANCE SYSTEM FOR PROVIDING GUIDED TRACTION CONTROL SETTINGS BASED ON VEHICLE FRICTION CONDITIONS

(71) Applicant: Volvo Truck Corporation, Goteborg (SE)

(72) Inventors: Julien Therien, Marsonnas (FR); Jean Khoury, Lyon (FR)

(21) Appl. No.: 17/939,079

(22) Filed: Sep. 7, 2022

(51) Int. Cl. B60W 40/068; B60W 50/10; B60W 50/14

(52) U.S. Cl. CPC B60W 40/068; B60W 50/10; B60W 50/14; B60W 2050/146; B60W 2552/40

(57) ABSTRACT

Traction control guidance system for providing guided traction control settings based on vehicle friction conditions. The traction control guidance system is configured to receive data relating to friction conditions experienced by the vehicle. The traction control guidance system is configured to compare the friction data to recommended traction control setting stored in memory according to a traction control setting guidance profile and provide to a user/driver the recommendations for traction control settings to be activated as traction control setting guidance. If the user/driver accepts the traction control setting guidance, this will cause a vehicle controller to activate the traction control settings according to the traction control settings included in the traction control setting guidance. In this manner, the user/driver is presented with recommended traction control settings to be activated for the current friction conditions of the vehicle without having to manually determine and set the desired traction control settings.

### TECHNICAL FIELD

The disclosure relates generally to traction settings for a vehicle, including a heavy duty vehicle. In particular aspects, the disclosure relates to a traction control guidance system for providing guided traction control settings based on vehicle friction conditions.

The disclosure can be applied in heavy-duty vehicles, such as trucks, buses, and construction equipment. Although the aspects will be described with respect to a particular vehicle, the disclosure is not restricted to any particular vehicle or type of vehicle.

### BACKGROUND

Vehicles today are commonly equipped with traction control features. Traction control is an active safety feature that helps to keep traction between tires of a vehicle and a road in slippery or other dangerous conditions. To provide traction control features in a vehicle, the vehicle may be equipped with a traction control system (TCS). When the TCS system is activated, the TCS controls the transmission and engine to prevent the tires from spinning on slippery surfaces, and increases traction when accelerating.

A TCS can include a number of different traction features that when activated, perform a variety of functions related to traction intended for various road and load conditions. With a vehicle equipped with such a TCS that has various traction control features, the user/driver must know which traction control features to activate, and in the desired combinations, to achieve the desired traction control operation of the vehicle.

### SUMMARY

According to an aspect of the disclosure, a traction control guidance system for providing guided traction control settings based on vehicle friction conditions is provided. In exemplary aspects, the traction control guidance system is provided in a vehicle. The traction control guidance system includes a controller (e.g., a microcontroller, processor) that can be part of a computing device that executes software for example. The traction control guidance system can be provided as a separate controller or as part of a vehicle controller that controls other operations of the vehicle, including traction control. In exemplary aspects, the traction control guidance system is configured to receive data relating to friction conditions experienced by the vehicle. For example, this friction data could be data received directly or indirectly from sensors that measure information related to friction conditions experienced by the vehicle. As another example, the friction data could be data received from the vehicle controller that generates the data based on settings and/or data measured from sensors, or calculations thereof. The traction control guidance system is configured to compare the friction data to a traction control setting profile stored in memory, and based on the comparison, provide to a user/driver the recommendations for traction control settings to be activated as traction control setting guidance. In one example, the user/driver is free to either accept the traction control setting guidance or not accept the traction control setting guidance. If the user/driver selects to accept the traction control setting guidance, this will cause the vehicle controller to activate such selected traction control settings according to the traction control settings included in the traction control setting guidance. In this manner, the user/driver is presented with recommended traction control settings to be activated for the current friction conditions of the vehicle without having to manually determine and set the desired traction control settings. The user/driver may not have sufficient experience and/or data regarding the friction conditions experienced by the vehicle to make the best decision for traction control settings. The user can also choose to activate or de-activate traction control settings outside of the traction control setting guidance.

In one example, the traction control guidance system is configured to display the current traction control setting statuses (e.g., on or off) together on a display for convenience, which may be graphical user interface (GUI) display. The GUI display is configured to provide visual, touch control buttons for activation and deactivation of traction control settings. The traction control guidance system can also display the traction control setting guidance to the user/driver on the display as a prompt to accept, which can then be accepted by the user/driver to cause the traction control settings in the traction control setting guidance to be activated.

As another example, the traction control guidance system can recommend a single traction control feature or a combination of traction control features within a traction control setting guidance provided to a user/driver. For example, the traction control guidance system can recommend a differential lock feature as part of traction control setting guidance to force the wheels of a selected axle to turn at the same speed thus increasing the number of driven wheels, when activated. As another example, the traction control guidance system can recommend an optitrack feature as part of traction control setting guidance to control hydraulics to transfer torque from the engine to a front axle of the vehicle by controlling hydraulic pumps and motors to improve traction, when activated. As another example, the traction control guidance system can recommend an offroad mode feature as part of traction control setting guidance to place the anti-slip regulation (ASR) and gearbox in an offroad mode to allow more wheel slipping, which in return allows more power to be transferred from the engine to the axles, when activated. As another example, the traction control guidance system can recommend a muddy site feature as part of traction control setting guidance to prevent heavy pushing of the accelerator pedal to avoid over revving of the engine when the vehicle is detected to be encountering multiple heavy road bumps, when activated. As another example, the traction control guidance system can recommend an axle load optimization feature as part of traction control setting guidance that engages hydraulics to lift an axle that has less load to transfer and/or balance load on the axles of the vehicle, when activated. Activating axle load optimization can assist in providing increased traction for a vehicle moving from a standstill on a slippery road.

In another example, the traction control guidance system is configured to continue to monitor the traction conditions experienced by the vehicle according to the received friction data. In another example, if the traction of the vehicle is deemed to be insufficient, the traction control guidance system can alter the traction control setting guidance provided to the user/driver to have an intended effect of increasing vehicle traction. If accepted by the user/driver, the traction control features according to the updated traction control setting guidance will be activated and/or deactivated according to the traction control setting guidance to increase the traction of the vehicle. In another example, if the traction of the vehicle is deemed to be sufficient, the traction control guidance system can also alter the traction control setting guidance provided to the user/driver, having the effect of reducing vehicle traction. If accepted by the user/driver, the traction control features according to the updated traction control setting guidance will be activated and/or deactivated to decrease the traction of the vehicle. The traction control guidance system can continue to determine and provide updated traction control setting guidance to a user/driver dynamically in response to determined traction conditions of the vehicle.

According to another aspect of the disclosure, a method is provided. The method comprises receiving, by a processor of at least one computing device, friction data relating to at least one friction condition experienced by a vehicle. The method also comprises comparing, by the processor, the received friction data to at least one traction control setting profile each comprising one or more traction control settings. The method also comprises determining, by the processor, a recommended traction control setting profile of the at least one traction control setting profile corresponding to the received friction data. The method also comprises communicating, by the processor, a recommended at least one traction control setting of the one or more traction control settings for the recommended traction control setting profile to a display, to be displayed.

According to another aspect of the disclosure, a vehicle comprising a processor device configured to perform the method described in the immediately preceding paragraph is provided.

According to another aspect of the disclosure, a computer system is provided. The computer system comprises at least one computing device comprising a processor device configured to: receive friction data relating to at least one friction condition experienced by a vehicle, compare the received friction data to at least one traction control setting profile each comprising one or more traction control settings, determine a recommended traction control setting profile of the at least one traction control setting profile corresponding to the received friction data, and communicate a recommended at least one traction control setting of the one or more traction control settings for the recommended traction control setting profile to a display, to be displayed.

According to another aspect of the disclosure, a non-transitory computer-readable storage medium is provided. The non-transitory computer-readable storage medium comprises programming instructions, which, when executed by a processor device of a computing system, cause the processor device to: receive friction data relating to at least one friction condition experienced by a vehicle, compare the received friction data to at least one traction control setting profile each comprising one or more traction control settings, determine a recommended traction control setting profile of the at least one traction control setting profile corresponding to the received friction data, and communicate a recommended at least one traction control setting of the one or more traction control settings for the recommended traction control setting profile to a display, to be displayed.

Additional features and advantages are disclosed in the following description, claims, and drawings, and in part will be readily apparent therefrom to those skilled in the art or recognized by practicing the embodiments as described herein.

### BRIEF DESCRIPTION OF THE DRAWINGS

With reference to the appended drawings, below follows a more detailed description of embodiments of the invention cited as examples.

FIG. 1 is an exemplary vehicle that includes traction control system (TCS) that can have various traction control features that each can be engaged to control operation of the vehicle to increase traction between the vehicle tires and the road;

FIG. 2 is a display that includes a graphical user interface (GUI) that can be displayed on a display in a vehicle, including the vehicle in FIG. 1, for displaying current traction control settings for the vehicle and for providing suggested, guided traction control settings to a user/driver to be activated based on friction conditions experienced by the vehicle according to one example;

FIG. 3 is a traction control guidance system that can be included in a vehicle, including the vehicle in FIG. 1, and that receives friction data of vehicle traction conditions experienced by a vehicle, and generates guided traction control settings based on the friction data, to be communicated to a user/driver of the vehicle suggested for activation according to one example;

FIG. 4 is a diagram illustrating an exemplary parameters that can be used by the traction control guidance system in FIG. 3 to generate guided traction control settings to be communicated to a user/driver of the vehicle suggested for activation according to one example;

FIG. 5 is a flowchart of an exemplary method that can be performed by the traction control guidance system in FIG. 3 to determine and generate guided traction control settings to be communicated to a user/driver of the vehicle suggested for activation based on vehicle traction conditions according to one example;

FIG. 6A is a diagram illustrating an exemplary average to high friction and low rolling resistance conditions traction control setting profile used by the traction control guidance system in FIG. 3 to determine guided traction control settings based on the friction data, when the vehicle is experiencing average to high friction and lower rolling resistance conditions in one example;

FIG. 6B is a diagram illustrating another exemplary low friction and low rolling resistance traction control setting profile used by the traction control guidance system in FIG. 3 to determine guided traction control settings based on the friction data, when the vehicle is experiencing low friction and lower rolling resistance conditions in one example;

FIG. 6C is a diagram illustrating another exemplary average friction and high rolling resistance traction control setting profile used by the traction control guidance system in FIG. 3 to determine guided traction control settings based on the friction data, when the vehicle is experiencing average friction and higher rolling resistance conditions in one example;

FIG. 7A is an illustration of an exemplary GUI generated by the traction control guidance system in FIG. 3 and displayed on a display in a vehicle, to visually indicate a current activated optitrack traction control setting for a vehicle according to one example;

FIG. 7B is an illustration of an exemplary GUI generated by the traction control guidance system in FIG. 3 and displayed on a display in a vehicle, to visually indicate a current activated muddy site traction control setting for a vehicle according to one example;

FIG. 7C is an illustration of an exemplary GUI generated by the traction control guidance system in FIG. 3 and displayed on a display in a vehicle, to visually indicate a current activated offroad mode traction control setting for a vehicle according to one example;

FIG. 7D is an illustration of an exemplary GUI generated by the traction control guidance system in FIG. 3 and displayed on a display in a vehicle, to visually indicate a current activated anti-slip regulation (ASR) off control setting for a vehicle according to one example;

FIG. 7E is an illustration of an exemplary GUI generated by the traction control guidance system in FIG. 3 and displayed on a display in a vehicle, to visually indicate a current activated axle load optimization traction control setting for a vehicle according to one example;

FIG. 7F is an illustration of an exemplary GUI generated by the traction control guidance system in FIG. 3 and displayed on a display in a vehicle, to visually indicate a current activated differential lock traction control setting for a vehicle according to one example; and

FIG. 8 is a block diagram of an exemplary computer system that can be included in a guided traction control system, including but not limited to the traction guidance control system in FIG. 3, to determine and generate guided traction control settings to be communicated to a user/driver of the vehicle suggested for activation based on vehicle traction conditions according to one example.

### DETAILED DESCRIPTION

The embodiments set forth below represent the necessary information to enable those skilled in the art to practice the embodiments and illustrate the best mode of practicing the embodiments.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

According to an aspect of the disclosure, a traction control guidance system for providing guided traction control settings based on vehicle friction conditions is provided. In exemplary aspects, the traction control guidance system is provided in a vehicle. The traction control guidance system includes a controller (e.g., a microcontroller, processor) that can be part of a computing device that executes software for example. The traction control guidance system can be provided as a separate controller or as part of a vehicle controller that controls other operations of the vehicle, including traction control. In exemplary aspects, the traction control guidance system is configured to receive data relating to friction conditions experienced by the vehicle. For example, this friction data could be data received directly or indirectly from sensors that measure information related to friction conditions experienced by the vehicle. As another example, the friction data could be data received from the vehicle controller that generates the data based on settings and/or data measured from sensors, or calculations thereof. The traction control guidance system is configured to compare the friction data to a traction control setting profile stored in memory, and based on the comparison, provide to a user/driver the recommendations for traction control settings to be activated as traction control setting guidance. In one example, the user/driver is free to either accept the traction control setting guidance or not accept the traction control setting guidance. If the user/driver selects to accept the traction control setting guidance, this will cause the vehicle controller to activate such selected traction control settings according to the traction control settings included in the traction control setting guidance. In this manner, the user/driver is presented with recommended traction control settings to be activated for the current friction conditions of the vehicle without having to manually determine and set the desired traction control settings. The user/driver may not have sufficient experience and/or data regarding the friction conditions experienced by the vehicle to make the best decision for traction control settings. The user/driver can also choose to activate or de-activate traction control settings outside of the traction control setting guidance.

In one example, the traction control guidance system is configured to display the current traction control setting statuses (e.g., on or off) together on a display for convenience, which may be graphical user interface (GUI) display. The GUI display is configured to provide visual, touch control buttons for activation and deactivation of traction control settings. The traction control guidance system can also display the traction control setting guidance to the user/driver on the display as a prompt to accept, which can then be accepted by the user/driver to cause the traction control settings in the traction control setting guidance to be activated.

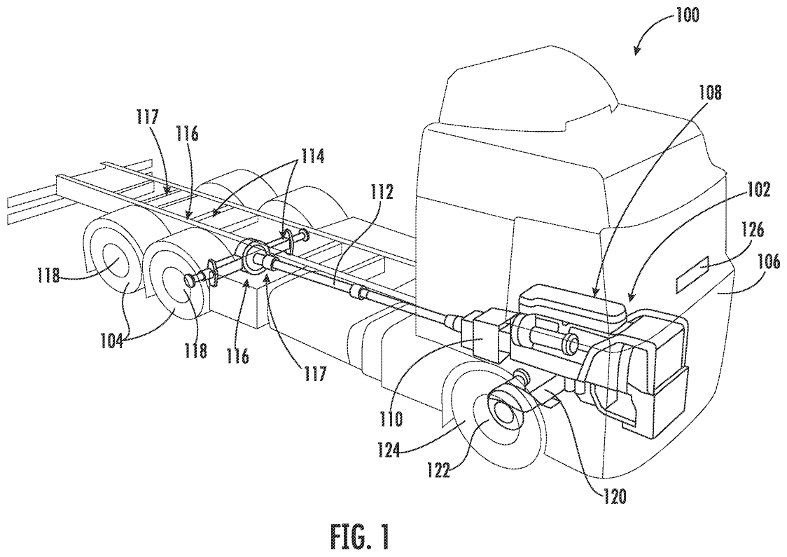

In this regard, FIG. 1 is an exemplary vehicle 100 that includes traction control system (TCS) 102. As discussed in more detail below, the TCS 102 can have various traction control features that each can be engaged to control operation of the vehicle 100 to increase traction between vehicle tires and a road. As shown in FIG. 1, the vehicle 100 includes a cab 106 that houses an engine 108. The engine 108 is coupled to a gearbox 110 to couple the engine 108 to a drive shaft 112 to turn the drive shaft 112. In turn, the drive shaft 112 is coupled to a rear differential 116 that is coupled to a rear axle 114. The rotation of the drive shaft 112 will cause the power of the engine 108 to be transferred to the rear axle 114 through the rear differential 116 to rotate wheels 118 coupled to the rear axle 114, and thus rotate the rear tires 104 mounted on the wheels 118. In this example, the vehicle 100 is a truck that includes two rear axles 114 that are coupled to respective wheels. In this example, the vehicle 100 is also equipped to be operated in four wheel drive (4WD), wherein the drive shaft 112 will be coupled to a front axle 120 that is coupled to front wheels 122, to drive power to the front wheels 122 causing the front wheels 122 and their mounted tires 124 to rotate. The vehicle 100 may also include rear axles pumps 117 that each include for example, a hydraulic pump, to control a lifting force applied to the respective rear axles 114 to alter the load distribution on the rear axles 114 of the vehicle 100.

As an example, the TCS 102 of the vehicle 100 may include a rear differential lock feature that, when activated, the rear differential 116 forces wheels on one or more rear axles 114 to turn at the same speed, thus increasing the number of driven wheels 118. The TCS 102 may also include an optitrack feature that, when activated, controls hydraulics to transfer torque from the engine 108 to the front axle 120 of the vehicle 100 by controlling hydraulic pumps and motors to improve traction. The TCS 102 may also include an offroad mode feature that when activated, places an anti-slip regulation (ASR) and gearbox 110 of the vehicle 100 in an offroad mode to allow more wheel slipping. This in return allows more power to be transferred from the engine 108 to the rear axles 114 and/or the front axle 120. The TCS 102 may also include a muddy site feature that when activated, prevents heavy pushing of the accelerator pedal to avoid over revving of the engine 108 when the vehicle 100 is detected to be encountering multiple heavy road bumps for example. The TCS 102 may also include an axle load optimization feature that when activated, engages hydraulics to lift the rear axle 114 and/or the front axle 120 that has less load to transfer and/or balance load on the rear axles 114 and/or the front axle 120 of the vehicle 100. Activating axle load optimization can assist in providing increased traction for the vehicle 100 moving from a standstill on a slippery road.

As discussed in more detail below, the vehicle 100 can also include a traction control guidance system 126 for providing guided traction control settings based on friction conditions experienced by the vehicle 100. As discussed in more detail below, the traction control guidance system 126 can be a processor or other electronic controller as part of a computing device, and that can execute software to perform tasks. For example, the traction control guidance system 126 can be configured to provide the guided traction control settings based on friction conditions experienced by the vehicle 100 to a user/driver as a recommendation so that the user/driver can choose to accept the recommendation for such traction control settings to then automatically be activated in response. The traction control guidance system 126 can be part of a computing device that executes software for example. In exemplary aspects, as discussed in more detail below, the traction control guidance system 126 is configured to receive data relating to friction conditions experienced by the vehicle 100. For example, this friction data could be data received directly or indirectly from sensors that measure information related to friction conditions experienced by the vehicle 100. The traction control guidance system 126 is configured to compare the friction data to a traction control setting profile stored in memory, and based on the comparison, provide to a user/driver the recommendations for traction control settings to be activated as traction control setting guidance. In one example, the user/driver is free to either accept the traction control setting guidance or not accept the traction control setting guidance. If the user/driver selects to accept the traction control setting guidance, this will cause the vehicle 100 to activate such selected traction control settings according to the traction control settings included in the traction control setting guidance. In this manner, the user/driver is presented with recommended traction control settings to be activated for the current friction conditions of the vehicle 100 without having to manually determine and set the desired traction control settings. The user/driver may not have sufficient experience and/or data regarding the friction conditions experienced by the vehicle 100 to make the best decision for traction control settings. The user/driver can also choose to activate or de-activate traction control settings outside of the traction control setting guidance.

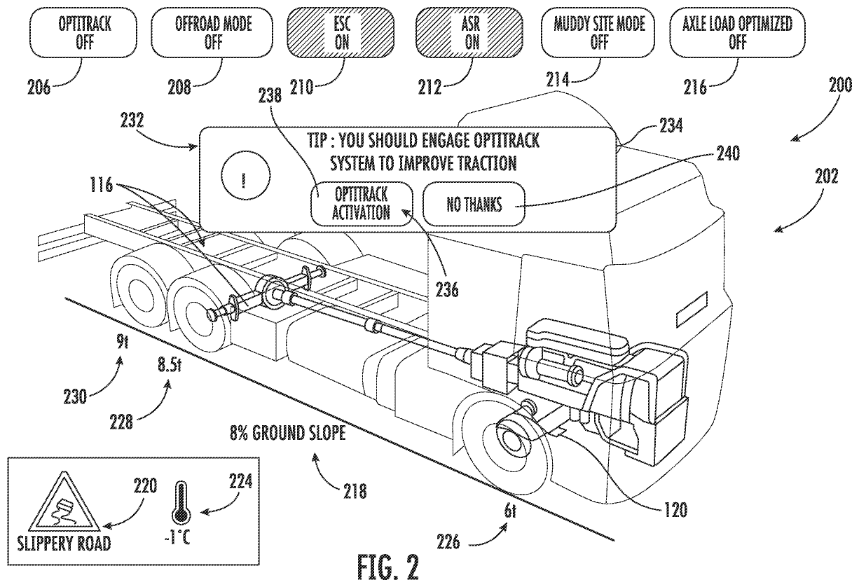

In on example, to provide a convenient method of displaying the current status of traction control settings activated by the TCS 102 for the vehicle 100 in FIG. 1 to a user/driver in a consolidated manner, a display 200 in FIG. 2 can be provided in the vehicle 100 and visually accessible to a user/driver. The display 200 is an electronic display device that includes a screen that displays visually-perceptible information (e.g., by controlling color and intensity of pixels). In this example, as discussed in more detail below, the traction control guidance system 126 is configured to display the current traction control setting activation statuses (e.g., on (activated) or off (de-activated)) together on the display 200 in a single graphical user interface (GUI) 202. The traction control guidance system 126 is also configured to generate a display of a vehicle 204 as part of the GUI 202 to visually show a representation of the vehicle 100 in FIG. 1 and its various components that are involved in traction control for the vehicle 100, described above, according to the current traction control feature(s) activated for the vehicle 100. In this manner, the user/driver is presented with consolidated information visually on the display 200 as to the status of traction control features in the vehicle 100 for convenience in access and control As will be discussed in more detail below, the traction control guidance system 126 can also be configured to highlight various components of the vehicle 204 to show which components are being actively controlled in some manner as part of a current activated traction control setting, so that a user/driver can easily have a visual indication of traction control features engaged for the vehicle 100 in one convenient area in the GUI 202 of the display 200.

With continuing reference to FIG. 2, the traction control guidance system 126 generates visual, touch control buttons in the GUI 202 to provide a current activation status of traction control settings available on the vehicle 100 as well as a visual indication if such traction control features are currently active. For example, the traction control guidance system 126 is configured to display the status of the optitrack traction control feature by generating an optitrack visual traction control button 206 as part of the GUI 202. The traction control guidance system 126 is configured to display the current status of the optitrack traction control feature as “ON” for activated, and “OFF” for not activated in the optitrack visual traction control button 206. As another example, the traction control guidance system 126 is configured to display the status of the offroad mode traction control feature by generating an offroad mode visual traction control button 208 as part of the GUI 202. The traction control guidance system 126 is configured to display the current status of the offroad mode traction control feature as “ON” for activated, and “OFF” for not activated in the offroad mode visual traction control button 208. As another example, the traction control guidance system 126 is configured to display the status of the electronic stability control (ESC) traction control feature by generating an ESC visual traction control button 210 as part of the GUI 202. The traction control guidance system 126 is configured to display the current status of the ESC traction control feature as “ON” for activated, and “OFF” for not activated in the ESC visual traction control button 210.

As another example, the traction control guidance system 126 is configured to display the status of the anti-slip regulation (ASR) traction control feature by generating an ASR visual traction control button 212 as part of the GUI 202. The traction control guidance system 126 is configured to display the current status of the ASR traction control feature as “ON” for activated, and “OFF” for not activated in the ASR visual traction control button 212. As another example, the traction control guidance system 126 is configured to display the status of the muddy site mode traction control feature by generating a muddy site mode traction control button 214 as part of the GUI 202. The traction control guidance system 126 is configured to display the current status of the muddy site mode traction control feature as “ON” for activated, and “OFF” for not activated in the muddy site mode visual traction control button 214. As another example, the traction control guidance system 126 is configured to display the status of the axle load optimization traction control feature by generating an axle load optimization button 216 as part of the GUI 202. The traction control guidance system 126 is configured to display the current status of the axle load optimization traction control feature as “ON” for activated, and “OFF” for not activated in the axle load optimization visual traction control button 216.

With continuing reference to FIG. 2, by providing the traction control guidance system 126 and display 200 providing the GUI 202, the traction control guidance system 126 can be configured to activate and deactivate the various traction control features available in the vehicle 100 based on user/driver input. The display 200 is configured to receive as input the physical selection by the user/driver of any traction control button 206, 208, 210, 212, 214, 216 described above to toggle the activation and deactivation of such traction control feature as the user/driver' s direction. The display 200 in this example is a touch screen display, such that a user/driver can press the area of traction control button 206, 208, 210, 212, 214, 216 displayed in the GUI 202 on the display 200 to toggle off and on the activation and de-activation of the optitrack traction control for the vehicle 100 as desired by the user/driver. For example, as shown in FIG. 2, in this example, the ESC visual traction control button 210 and ASR visual traction control button 212 are both controlled to indicate an “ON” status by the traction control guidance system 126 indicating that such traction control features are current activated, while the other traction control buttons 206, 208, 214, 216 indicate an “OFF” status meaning they are currently inactivated. The user/driver can simply press any of the traction control buttons 206, 208, 210, 212, 214, 216 to toggle their ON/OFF status, which in turn will cause the traction control guidance system 126 to communicate to the TCS 102 to activate or deactivate such traction control features for the vehicle 100.

As also shown in FIG. 2, the traction control guidance system 126 can also cause the current ground slope 218 experienced by the vehicle 100 to also be displayed as part of the GUI 202 on the display 200 for the user/driver' s convenience. The traction control guidance system 126 can also cause a current ground condition 220 experienced by the vehicle 100 as well as the outside ambient temperature of the vehicle 100 to be displayed as part of the GUI 202 on the display 200 for the user/driver's convenience. The traction control guidance system 126 can also cause load 226, 228, 230 (e.g., in tons) measured at each of the front axle 120 and rear axles 114 to be displayed as part of the GUI 202 on the display 200 for the user/driver' s convenience.

Further, as shown in FIG. 2, and described in more detail below, the traction control guidance system 126 can also generate a determined guided traction control settings recommendation 232 to be displayed visually in the GUI 202 on the display 200 to a user/driver based on friction conditions experienced by the vehicle 100. As shown in FIG. 2, the traction control guidance system 126 generated the guided traction control setting recommendation 232 as a pop-up window 234 that indicates the recommended traction control setting 232 (which is optitrack in this example) in the form of a guided traction control button 238. If the user/driver selects the guided traction control button 238, the traction control guidance system 126 will cause the guided traction control setting recommendation 232 to be communicated to the TCS 102 to then be activated as a traction control setting for the vehicle 100. The traction control guidance system 126 will also cause the traction control button 206, 208, 210, 212, 214, 216 as part of the GUI 202 to be updated to display the correct, current traction control statutes based on the guided traction control setting recommendation 232. In this manner, if the user/driver wants to accept the guided traction control setting recommendation 232 generated by the traction control guidance system 126, the user/driver can easily and conveniently choose to accept the recommendation with the selection of a single guided traction control button 238. If the user/driver does not want to accept the guided traction control setting recommendation 232 generated by the traction control guidance system 126, the user/driver can select a decline button 240 generated by the traction control guidance system 126 as part of the pop-up window 234 displayed on the display 200, in which case no current activated and deactivated traction control settings are changed by the TCS 102 and in the GUI 202.

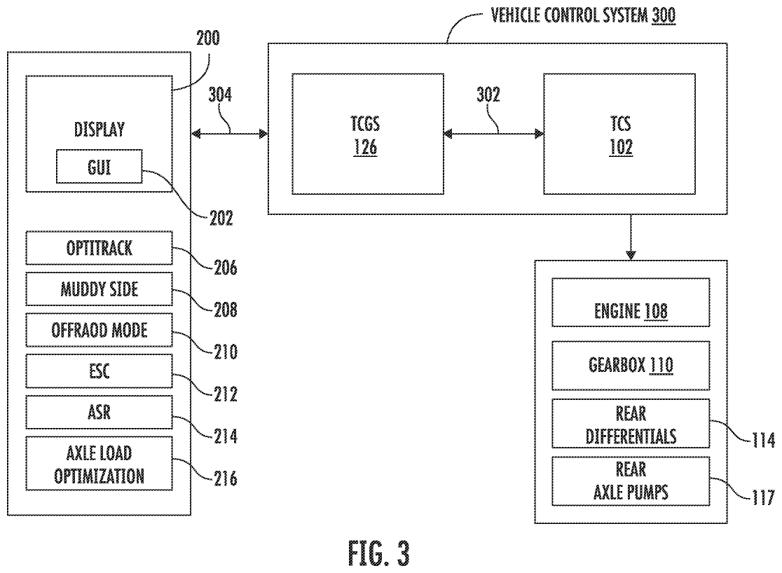

FIG. 3 is another diagram of a traction control guidance system 126 that can be included in a vehicle, including the vehicle 100 in FIG. 1, to generate guided traction control settings based on the friction data relating to the traction experienced by the vehicle. The traction control guidance system 126 is a processor (or central processing unit CPU)) as part of a computing device in this example that can execute software to perform tasks. In this example, the traction control guidance system 126 is provided as part of a vehicle control system 300, which may also be referred to as a vehicle controller. The traction control guidance system 126 is communicatively coupled through an interface 302 to the TCS 102, which as discussed above is configured to activate and deactivate traction control settings for a vehicle to control the traction control features of a vehicle, including vehicle 100. The vehicle control system 300 is described with reference to the exemplary vehicle 100 in FIG. 1. The TCS 102 is configured to control functions of the engine 108, the gearbox 110, the rear differentials 116 and the rear axle pump 117 to control various traction control features as described above. The TCS 102 can be an electronic control device, such as a processor (or CPU) as part of a computing device in this example that can execute software to perform tasks to control traction control for the vehicle 100.

With continuing reference to FIG. 3, the traction control guidance system 126 is communicatively coupled through an interface 304 to the display 200 to control the information displayed on the display 200. In this example, as discussed above and shown in the example in FIG. 2, the traction control guidance system 126 is configured to generate a GUI 202 to be displayed on the display 200 to a user/driver. The display 200 can be a touch screen display that allows a user/driver to touch the display 200 to provide input that is then communicated over the interface 304 to the traction control guidance system 126. For example, as discussed in FIG. 2 above, the GUI 202 can include the traction control buttons 206, 208, 210, 212, 214, 216 that can be controlled by the traction control guidance system 126 to indicate both a textual and visual indication of status as on or off, as well as providing input buttons that can be selected by the user/driver to toggle the on/off control for activation/deactivation of the respective traction control setting. In response to selection of a traction control buttons 206, 208, 210, 212, 214, 216 to change the activation status of a traction control setting, the display 200 communicates this response to the traction control guidance system 126, which in turn communicates the new setting for the selected traction control feature to the TCS 102. The TCS 102 then changes the traction control settings for the vehicle 100 to activate or deactivate the selected traction control feature according to the received input from the user/driver on the display 200. The traction control guidance system 126 also changes the GUI 202 to update the new activation status of the selected traction control feature by adjusting the textual and/or visual indicators for the relevant traction control button 206, 208, 210, 212, 214, 216 of the GUI 202.

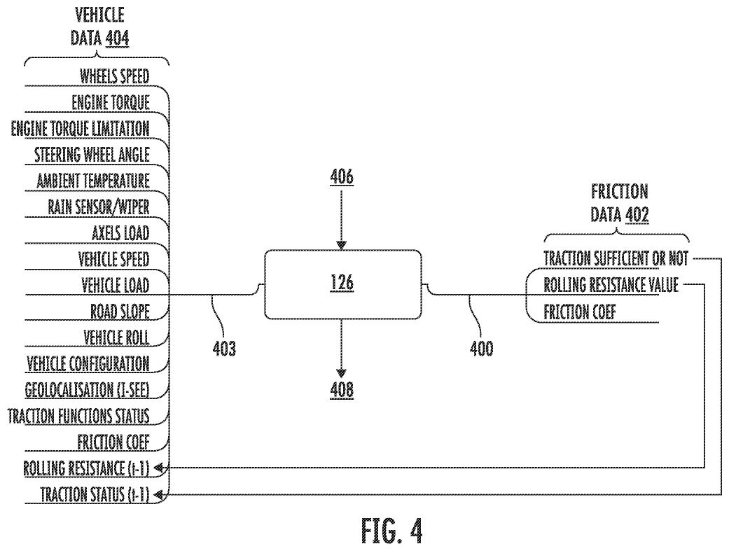

As discussed above, the traction control guidance system 126 is configured to provide guided traction control settings to a user/driver based on the traction conditions experienced by the vehicle 100. In this regard, FIG. 4 is a diagram illustrating exemplary parameters that can be used by the traction control guidance system 126 in FIG. 3 to generate guided traction control settings to be communicated to a user/driver of the vehicle 100 suggested for activation according to one example. As shown in FIG. 4, the traction control guidance system 126 in this example is configured to generate as outputs 400, friction data 402 that can then be used to determine guided traction control settings to be provided to the display 200 in FIG. 2 for example. The friction data 402 in this example includes rolling resistance, friction coefficient, and an indication if traction of the vehicle 100 is sufficient or insufficient. The traction control guidance system 126 is configured to generate the friction data 402 based on one or more types of vehicle data 404 that is provided by the TCS 102 or other component of the vehicle 100, to the traction control guidance system 126 through an interface 403 as inputs. The vehicle data 404 can include, for example, one or more of the following friction data: wheel speed, engine torque, engine torque limitation, steering wheel angle, ambient temperature, rain sensor/wiper information, axle loads, vehicle speed, vehicle load, road slope, vehicle roll, vehicle configuration, geolocalization, traction function status, friction coefficient, rolling resistance, and traction status. Note that the friction data 402 can also include one or more of the vehicle data 404 in its original form.

Rolling resistance, sometimes called rolling friction or rolling drag, is the force resisting the motion when a body (such as a ball, tire, or wheel) rolls on a surface. It is mainly caused by non-elastic effects; that is, not all the energy needed for deformation (or movement) of the wheel, roadbed, etc., is recovered when the pressure is removed. Factors that contribute to rolling resistance are the (amount of) deformation of the wheels, the deformation of the roadbed surface, and movement below the surface. Additional contributing factors include wheel diameter, load on wheel, surface adhesion, sliding, and relative micro-sliding between the surfaces of contact. The losses due to hysteresis also depend strongly on the material properties of the wheel or tire and the surface. For example, a rubber tire will have higher rolling resistance on a paved road than a steel railroad wheel on a steel rail. Also, sand on the ground will give more rolling resistance than concrete. Sole rolling resistance factor is not dependent on speed.

The “rolling resistance coefficient” is defined by the following equation:

F=Cᵣᵣ N where

F is the rolling resistance force,
Cᵣᵣ is the dimensionless rolling resistance coefficient or coefficient of rolling friction (CRF), and
N is the normal force, the force perpendicular to the surface on which the wheel is rolling.

The above shows resistance proportional to Crr but does not explicitly show any variation with speed, loads, torque, surface roughness, diameter, tire inflation/wear, etc., because Crr itself varies with those factors. It might seem from the above definition of Crr that the rolling resistance is directly proportional to vehicle weight, but it is not.

The coefficient of rolling resistance for a slow rigid wheel on a perfectly elastic surface, not adjusted for velocity, can be calculated by:

$${C}_{rr} = \sqrt{\frac{z}{d}}$$

where
z is the sinkage depth
d is the diameter of the rigid wheel

As an alternative to using Cᵣᵣ one can use b which is a different roiling resistance coefficient or coefficient of rolling friction with dimension of length. It is defined by the following formula:

$$F = \frac{Nb}{r}$$

where
F is the rolling resistance force,
r is the wheel radius,
b is the rolling resistance coefficient or coefficient of rolling friction with dimension of length, and
N is the normal force.
The above equation, where resistance is inversely proportional to radius r seems to be based on the discredited “Coulomb's law” (Neither Coulomb's inverse square law nor Coulomb's law of friction). Equating this equation with the force per the rolling resistance coefficient, and solving for b, gives b=Cᵣᵣ r. Therefore, if a source gives rolling resistance coefficient as a dimensionless coefficient, it can be converted to b, having units of length, by multiplying Cᵣᵣ by wheel radius r.

Friction is desirable and important in supplying traction to facilitate motion on land. Most land vehicles rely on friction for acceleration, deceleration, and changing direction. Sudden reductions in traction can cause loss of control and accidents.

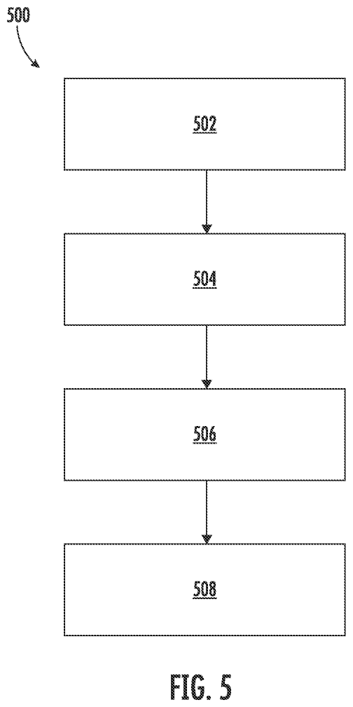

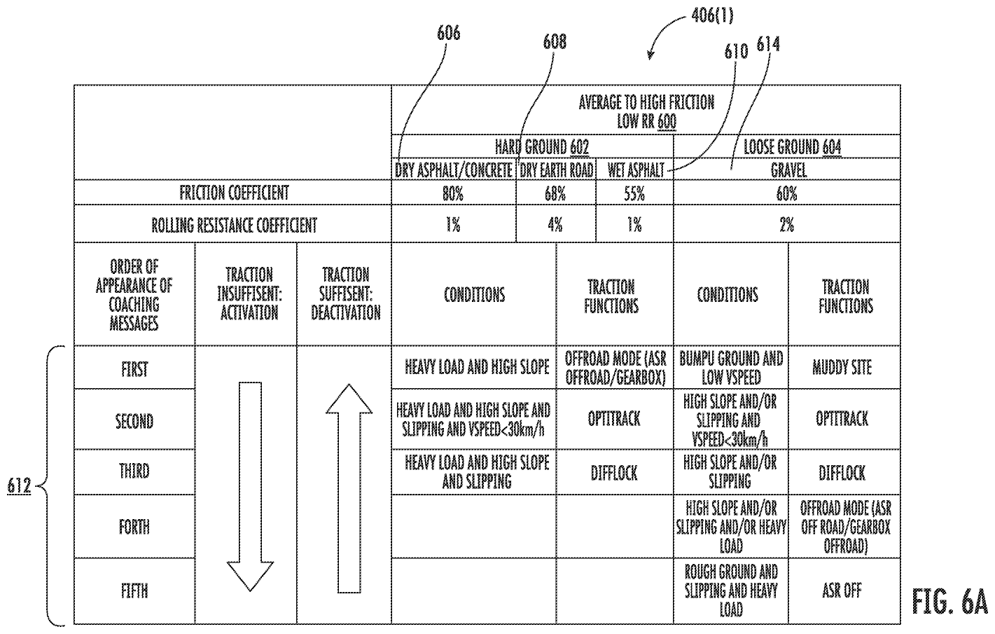

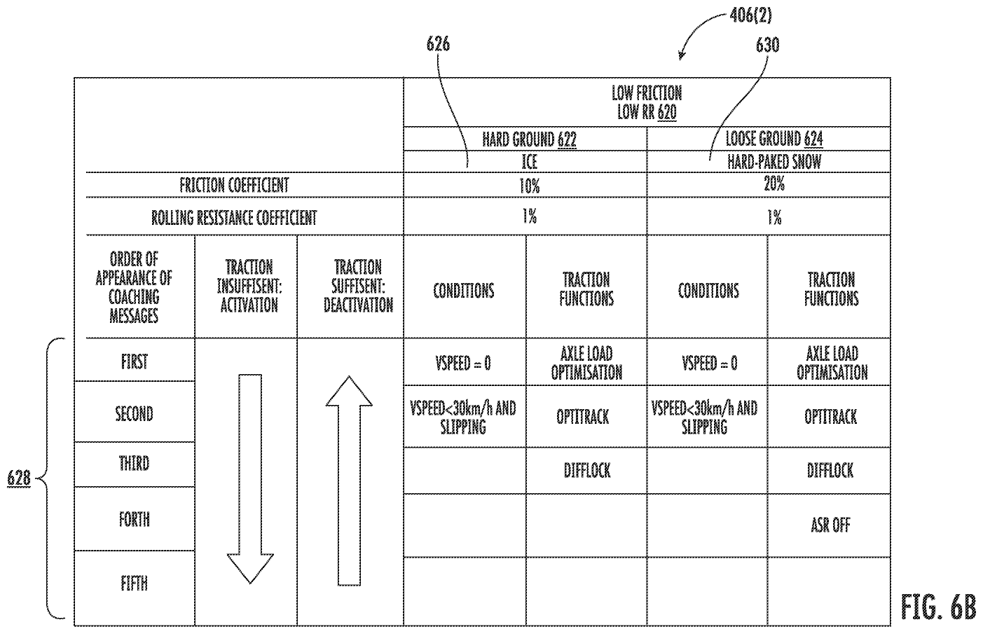

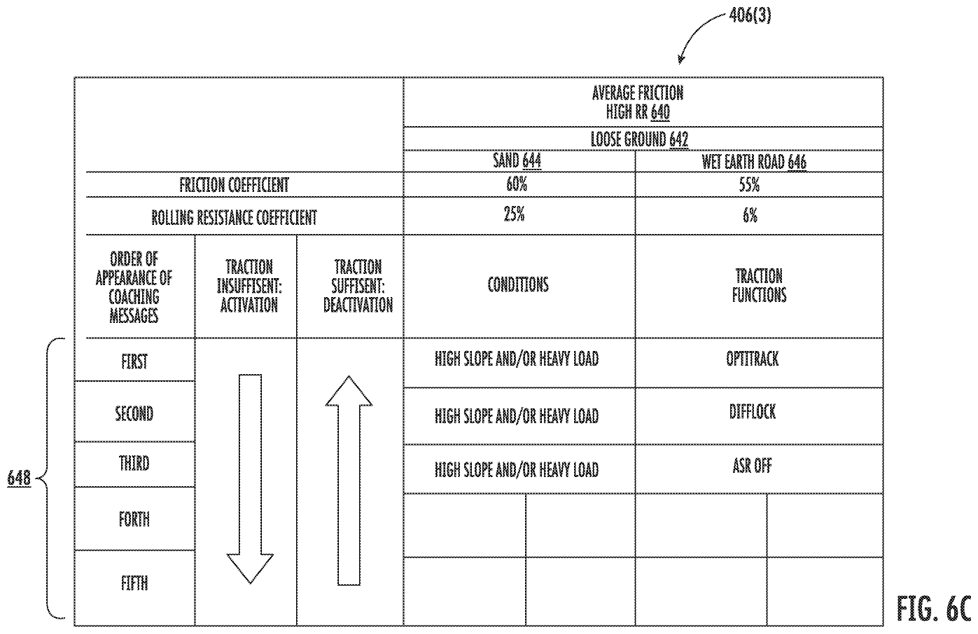

As shown in the exemplary process 500 of providing guided traction control settings in FIG. 5 with reference to FIG. 4, the traction control guidance system 126 is configured to receive the friction data 402 relating to at least one friction condition experienced by a vehicle 100 (block 502 in FIG. 5). The traction control guidance system 126 is configured to compare the received friction data 402 to at least one traction control setting profile 406 each comprising one or more traction control settings (block 504 in FIG. 5). Examples of traction control setting profiles 406 that include one or more traction control settings are described later below with regard to FIGS. 6A-6C. The traction control guidance system 126 is then configured to determine a recommended traction control setting profile 406 of the at least one traction control setting profile 406 corresponding to the received friction data 402 (block 506 in FIG. 5). The traction control guidance system 126 is then configured to communicate a recommended at least one traction control setting of the one or more traction control settings as a guided traction control setting recommendation 408 (e.g., guided traction control setting recommendation 232 in FIG. 2) for the recommended traction control setting profile 406 to a display 200, to be displayed (block 508 in FIG. 5).

FIG. 6A is a diagram illustrating an exemplary average to high friction and low rolling resistance traction control setting profile 600 as one traction control setting profile 406(1) that can used by the traction control guidance system 126 in FIG. 3 to determine guided traction control settings based on friction data, such as the friction data 402 in FIG. 4. The high friction and low rolling resistance traction control setting profile 600 in FIG. 6A in this example for when the vehicle 100 is determined by the traction control guidance system 126 to be experiencing average to high friction and lower rolling resistance conditions, based on the received friction data 402. The traction control guidance system 126 to processes the vehicle data 404 to determine the friction data 402 in FIG. 4 that can then be used to compare to one or more traction control setting profiles 406 that can include the high friction and low rolling resistance traction control setting profile 600. If, for example, the traction control guidance system 126 determines the friction data 402 best matches the average to high friction and low rolling resistance traction control setting profile 600 in FIG. 6A, as discussed in more detail below, the traction control guidance system 126 uses the traction control settings in the average to high friction and low rolling resistance traction control setting profile 600 to generate the guided traction control setting recommendation 408 to the user/driver.

In this regard, with reference to FIG. 6A, the average to high friction and low rolling resistance traction control setting profile 600 includes a hard ground traction control setting profile 602 and a loose ground traction control setting profile 604. The hard ground traction control setting profile 602 and a loose ground traction control setting profile 604 for the profile 600 are based on the friction coefficient and rolling resistance coefficient calculated as friction data 402 by the traction control guidance system 126 based on the vehicle data 404 in FIG. 4 in this example. The hard ground traction control setting profiles 602 includes the traction control setting sub-profiles as dry asphalt/concrete profile 606, dry earth road profile 608, and wet asphalt profile 610. In this example, the dry asphalt/concrete profile 606 corresponds to an 80% friction coefficient and a 1% rolling resistance coefficient, the dry earth road profile 608 corresponds to a 68% friction coefficient and a 4% rolling resistance coefficient, and the wet asphalt profile 610 corresponds to a 55% friction coefficient and a 1% rolling resistance coefficient. In another example, the hard ground traction control setting profiles 602 could include the traction control setting sub-profile as a >=75% friction coefficient and a <=2% rolling resistance coefficient. In another example, the hard ground traction control setting profiles 602 could include the traction control setting sub-profile as a >=62% friction coefficient and a 3%-6% rolling resistance coefficient. In yet another example, the hard ground traction control setting profiles 602 could include the traction control setting sub-profile as a 30%-55% friction coefficient and a <=2% rolling resistance coefficient. If the traction control guidance system 126 determines that the friction coefficient and rolling resistance coefficient of one of the hard ground traction control setting profiles 602 best corresponds to the friction data 402, the traction control guidance system 126 can use the traction control settings 612 corresponding to the selected hard ground traction control setting profile 602 to provide the guided traction control setting recommendation 408 to the display 200 to be presented to the user/driver.

With continuing reference to FIG. 6A, for each of the three traction control setting sub-profiles of dry asphalt/concrete profile 606, dry earth road profile 608, and wet asphalt profile 610, the traction control settings are the same. The first traction control setting for the hard ground traction control setting profile 602 is offroad mode. The second traction control setting for the hard ground traction control setting profile 602 is optitrack. The third traction control setting for the hard ground traction control setting profile 602 is differential lock. For the first instance of a determined fit between the friction data 402 and the hard ground traction control setting profile 602, the traction control guidance system 126 will generate the first traction control setting in FIG. 6A (offroad mode) as the guided traction control setting recommendation 408 to the display 200 to be presented to the user/driver. The traction control guidance system 126 will continue to receive the vehicle data 404 and determine the friction data 402 based on the received vehicle data 404. If the traction control guidance system 126 determines that its friction data 402 still indicates an insufficient traction for the vehicle 100, and the hard ground traction control setting profile 602 is still determined to be the best fit of the friction data 402 to a traction control setting profile 406, the traction control guidance system 126 will then generate the second traction control setting FIG. 6A (optitrack) as the guided traction control setting recommendation 408 to the display 200 to be presented to the user/driver as an additional traction control that will increase traction for the vehicle 100 if the user/driver had selected the first traction control setting.

If the traction control guidance system 126 determines that its friction data 402 still indicates an insufficient traction for the vehicle 100, and the hard ground traction control setting profile 602 is still determined to be the best fit of the friction data 402 to a traction control setting profile 406, the traction control guidance system 126 will then generate the third traction control setting in FIG. 6A (differential lock) as the guided traction control setting recommendation 408 to the display 200 to be presented to the user/driver as an additional traction control that will increase traction for the vehicle 100, if the user/driver had selected the second traction control setting. If at any time, the traction control guidance system 126 determines that its friction data 402 indicates a sufficient traction for the vehicle 100, and the hard ground traction control setting profile 602 is still determined to be the best fit of the friction data 402 to a traction control setting profile 406, the traction control guidance system 126 will then reduce the traction control setting to the next lower setting as the guided traction control setting recommendation 408 to the display 200 to be presented to the user/driver as reduced traction control that will decrease traction for the vehicle 100. This process continues in a repeated manner.

If the traction control guidance system 126 determines the hard ground traction control setting profile 602 is not determined to be the best fit of the friction data 402 to a traction control setting profile 406, the traction control guidance system 126 will use a different traction control setting profile 406 to provide the guided traction control setting recommendation 408 to the user/driver, including the traction control setting profile 406 in FIGS. 6B and 6C.

With continued reference to FIG. 6A, the loose ground traction control setting profiles 604 include the traction control setting sub-profile as a gravel traction control setting profile 614. In this example, the gravel traction control setting sub-profile 614 in this example corresponds to a 60% friction coefficient and a 2% rolling resistance coefficient. As another example, the gravel traction control setting sub-profile 614 could corresponds to a 55%-65% friction coefficient and a <=3% rolling resistance coefficient. If the traction control guidance system 126 determines that the friction coefficient and rolling resistance coefficient of the loose ground traction control setting profile 604 best corresponds to the friction data 402, the traction control guidance system 126 can use the traction control settings 612 corresponding to the loose ground traction control setting profile 604 to provide the guided traction control setting recommendation 408 to the display 200 to be presented to the user/driver. The first traction control setting for the loose ground traction control setting profile 604 is muddy site. The second traction control setting for the loose ground traction control setting profile 604 is optitrack. The third traction control setting for the loose ground traction control setting profile 604 is differential lock. The fourth traction control setting for the loose ground traction control setting profile 604 is offroad mode. The fifth traction control setting for the loose ground traction control setting profile 604 is ASR off.

For the first instance of a determined fit between the friction data 402 and the loose ground traction control setting profile 604, the traction control guidance system 126 will generate the first traction control setting in FIG. 6A (muddy site) as the guided traction control setting recommendation 408 to the display 200 to be presented to the user/driver. The traction control guidance system 126 will continue to receive the vehicle data 404 and determine the friction data 402 based on the received vehicle data 404. If the traction control guidance system 126 determines that its friction data 402 still indicates an insufficient traction for the vehicle 100, and the loose ground traction control setting profile 604 is still determined to be the best fit of the friction data 402 to a traction control setting profile 406, the traction control guidance system 126 will then generate the second traction control setting in FIG. 6A (optitrack) as the guided traction control setting recommendation 408 to the display 200 to be presented to the user/driver as an additional traction control that will increase traction for the vehicle 100, if the user/driver had selected the first traction control setting. If the traction control guidance system 126 determines that its friction data 402 still indicates an insufficient traction for the vehicle 100, and the loose ground traction control setting profile 604 is still determined to be the best fit of the friction data 402 to a traction control setting profile 406, the traction control guidance system 126 will then generate the third traction control setting in FIG. 6A (differential lock) as the guided traction control setting recommendation 408 to the display 200 to be presented to the user/driver as an additional traction control that will increase traction for the vehicle 100, if the user/driver had selected the second traction control setting.

If the traction control guidance system 126 determines that its friction data 402 still indicates an insufficient traction for the vehicle 100, and the loose ground traction control setting profile 604 is still determined to be the best fit of the friction data 402 to a traction control setting profile 406, the traction control guidance system 126 will then generate the fourth traction control setting in FIG. 6A (offroad mode) as the guided traction control setting recommendation 408 to the display 200 to be presented to the user/driver as an additional traction control that will increase traction for the vehicle 100, if the user/driver had selected the third traction control setting. If the traction control guidance system 126 determines that its friction data 402 still indicates an insufficient traction for the vehicle 100, and the loose ground traction control setting profile 604 is still determined to be the best fit of the friction data 402 to a traction control setting profile 406, the traction control guidance system 126 will then generate the fifth traction control setting in FIG. 6A (ASR off) as the guided traction control setting recommendation 408 to the display 200 to be presented to the user/driver as an additional traction control that will increase traction for the vehicle 100, if the user/driver had selected the fourth traction control setting.

If at any time, the traction control guidance system 126 determines that its friction data 402 indicates a sufficient traction for the vehicle 100, and the loose ground traction control setting profile 604 is still determined to be the best fit of the friction data 402 to a traction control setting profile 406, the traction control guidance system 126 will then reduce the traction control setting to the next lower traction control setting 612 as the guided traction control setting recommendation 408 to the display 200 to be presented to the user/driver as an reduced traction control that will decrease traction for the vehicle 100. This process continues in a repeated manner.

FIG. 6B is a diagram illustrating an exemplary low friction and low rolling resistance traction control setting profile 620 as another traction control setting profile 406(2) that can used by the traction control guidance system 126 in FIG. 3 to determine guided traction control settings based on friction data, such as the friction data 402 in FIG. 4. The low friction and low rolling resistance traction control setting profile 620 in FIG. 6B in this example for when the vehicle 100 is determined by the traction control guidance system 126 to be experiencing low friction and lower rolling resistance conditions, based on the received friction data 402. If for example, the traction control guidance system 126 determines the friction data 402 best matches the low friction and low rolling resistance traction control setting profile 620 in FIG. 6B, as discussed in more detail below, the traction control guidance system 126 uses the traction control settings in the low friction and low rolling resistance traction control setting profile 620 to generate the guided traction control setting recommendation 408 to the user/driver.

In this regard, with reference to FIG. 6B, the low friction and low rolling resistance conditions traction control setting profile 620 includes a hard ground traction control setting profile 622 and a loose ground traction control setting profile 624. The hard ground traction control setting profile 622 and a loose ground traction control setting profile 624 for the low friction and low rolling resistance conditions traction control setting profile 620 are based on the friction coefficient and rolling resistance coefficient calculated as friction data 402 by the traction control guidance system 126 based on the vehicle data 404 in FIG. 4 in this example. The hard ground traction control setting profile 622 in this example includes an ice traction control setting sub-profile 626 that corresponds to a 10% friction coefficient and a 1% rolling resistance coefficient. In another example, the hard ground traction control setting profile 622 could correspond to a <=15% friction coefficient and a <=2% rolling resistance coefficient. If the traction control guidance system 126 determines that the friction coefficient and rolling resistance coefficient of the hard ground traction control setting profiles 622 best corresponds to the friction data 402, the traction control guidance system 126 can use the traction control settings 628 corresponding to the hard ground traction control setting profile 622 to provide the guided traction control setting recommendation 408 to the display 200 to be presented to the user/driver.

With continuing reference to FIG. 6B, the first traction control setting for the hard ground traction control setting profile 622 is axle load optimization. The second traction control setting for the hard ground traction control setting profile 622 is optitrack. The third traction control setting for the hard ground traction control setting profile 622 is differential lock. For the first instance of a determined fit between the friction data 402 and the hard ground traction control setting profile 622, the traction control guidance system 126 will generate the first traction control setting in FIG. 6B (axle load optimization) as the guided traction control setting recommendation 408 to the display 200 to be presented to the user/driver. The traction control guidance system 126 will continue to receive the vehicle data 404 and determine the friction data 402 based on the received vehicle data 404. If the traction control guidance system 126 determines that its friction data 402 still indicates an insufficient traction for the vehicle 100, and the hard ground traction control setting profile 622 is still determined to be the best fit of the friction data 402 to a traction control setting profile 406, the traction control guidance system 126 will then generate the second traction control setting in FIG. 6B (optitrack) as the guided traction control setting recommendation 408 to the display 200 to be presented to the user/driver as an additional traction control that will increase traction for the vehicle 100 if the user/driver had selected the first traction control setting. If the traction control guidance system 126 determines that its friction data 402 still indicates an insufficient traction for the vehicle 100, and the hard ground traction control setting profile 622 is still determined to be the best fit of the friction data 402 to a traction control setting profile 406, the traction control guidance system 126 will then generate the third traction control setting in FIG. 6B (differential lock) as the guided traction control setting recommendation 408 to the display 200 to be presented to the user/driver as an additional traction control that will increase traction for the vehicle 100, if the user/driver had selected the second traction control setting If at any time, the traction control guidance system 126 determines that its friction data 402 indicates a sufficient traction for the vehicle 100, and the hard ground traction control setting profile 622 is still determined to be the best fit of the friction data 402 to a traction control setting profile 406, the traction control guidance system 126 will then reduce the traction control setting to the next lower traction control setting 628 as the guided traction control setting recommendation 408 to the display 200 to be presented to the user/driver as an reduced traction control that will decrease traction for the vehicle 100. This process continues in a repeated manner.

If the traction control guidance system 126 determines the hard ground traction control setting profile 622 is not determined to be the best fit of the friction data 402 to a traction control setting profile 406, the traction control guidance system 126 will use a different traction control setting profile 406 to provided the guided traction control setting recommendation 408 to the user/driver, including the traction control setting profile 406 in FIGS. 6A and 6C.

With continued reference to FIG. 6B, the loose ground traction control setting profile 624 includes the traction control setting sub-profile as a hard-packed snow traction control setting sub-profile 630. In this example, the hard-packed snow profile 630 corresponds to a 20% friction coefficient and a 1% rolling resistance coefficient. In another example, the hard-packed snow profile 630 could corresponds to a 15%-30% friction coefficient and a <=2% rolling resistance coefficient. If the traction control guidance system 126 determines that the friction coefficient and rolling resistance coefficient of the loose ground traction control setting profile 624 best corresponds to the friction data 402, the traction control guidance system 126 can use the traction control settings 628 corresponding to the loose ground traction control setting profile 624 to provide the guided traction control setting recommendation 408 to the display 200 to be presented to the user/driver. The first traction control setting for the loose ground traction control setting profile 624 is axle load optimization. The second traction control setting for the loose ground traction control setting profile 624 is optitrack. The third traction control setting for the loose ground traction control setting profile 624 is differential lock. The fourth traction control setting for the loose ground traction control setting profile 624 is ASR off.

For the first instance of a determined fit between the friction data 402 and the loose ground traction control setting profile 624, the traction control guidance system 126 will generate the first traction control setting in FIG. 6B (axle load optimization) as the guided traction control setting recommendation 408 to the display 200 to be presented to the user/driver. The traction control guidance system 126 will continue to receive the vehicle data 404 and determine the friction data 402 based on the received vehicle data 404. If the traction control guidance system 126 determines that its friction data 402 still indicates an insufficient traction for the vehicle 100, and the loose ground traction control setting profile 624 is still determined to be the best fit of the friction data 402 to a traction control setting profile 406, the traction control guidance system 126 will then generate the second traction control setting in FIG. 6B (optitrack) as the guided traction control setting recommendation 408 to the display 200 to be presented to the user/driver as an additional traction control that will increase traction for the vehicle 100, if the user/driver had selected the first traction control setting. If the traction control guidance system 126 determines that its friction data 402 still indicates an insufficient traction for the vehicle 100, and the loose ground traction control setting profile 624 is still determined to be the best fit of the friction data 402 to a traction control setting profile 406, the traction control guidance system 126 will then generate the third traction control setting in FIG. 6B (differential lock) as the guided traction control setting recommendation 408 to the display 200 to be presented to the user/driver as an additional traction control that will increase traction for the vehicle 100, if the user/driver had selected the second traction control setting. If the traction control guidance system 126 determines that its friction data 402 still indicates an insufficient traction for the vehicle 100, and the loose ground traction control setting profile 624 is still determined to be the best fit of the friction data 402 to a traction control setting profile 406, the traction control guidance system 126 will then generate the fourth traction control setting in FIG. 6B (ASR off) as the guided traction control setting recommendation 408 to the display 200 to be presented to the user/driver as an additional traction control that will increase traction for the vehicle 100, if the user/driver had selected the third traction control setting.

If at any time, the traction control guidance system 126 determines that its friction data 402 indicates a sufficient traction for the vehicle 100, and the loose ground traction control setting profile 624 is still determined to be the best fit of the friction data 402 to a traction control setting profile 406, the traction control guidance system 126 will then reduce the traction control setting to the next lower traction control setting 628 as the guided traction control setting recommendation 408 to the display 200 to be presented to the user/driver as an reduced traction control that will decrease traction for the vehicle 100. This process continues in a repeated manner.

FIG. 6C is a diagram illustrating an exemplary average friction and high rolling resistance traction control setting profile 640 as another traction control setting profile 406(3) that can used by the traction control guidance system 126 in FIG. 3 to determine guided traction control settings based on friction data, such as the friction data 402 in FIG. 4. The average friction and high rolling resistance traction control setting profile 640 in FIG. 6C in this example for when the vehicle 100 is determined by the traction control guidance system 126 to be experiencing average friction and higher rolling resistance conditions, based on the received friction data 402. If for example, the traction control guidance system 126 determines the friction data 402 best matches the average friction and high rolling resistance traction control setting profile 640 in FIG. 6C, as discussed in more detail below, the traction control guidance system 126 uses the traction control settings in the average friction and high rolling resistance traction control setting profile 640 to generate the guided traction control setting recommendation 408 to the user/driver.

In this regard, with reference to FIG. 6C, the average friction and high rolling resistance conditions traction control setting profile 640 includes a loose ground traction control setting profile 642. The loose ground traction control setting profile 642 for the average friction and high rolling resistance conditions traction control setting profile 640 is based on the friction coefficient and rolling resistance coefficient calculated as friction data 402 by the traction control guidance system 126 based on the vehicle data 404 in FIG. 4 in this example. In this example, the loose ground traction control setting profile 642 includes a sand traction control setting sub-profile 644 that corresponds to a 60% friction coefficient and a 25% rolling resistance coefficient, and a wet earth road traction control setting sub-profile 646 that corresponds to a 55% friction coefficient and a 6% rolling resistance coefficient. In another example, the loose ground traction control setting profile 642 could correspond to a >=50% friction coefficient and a >=10% rolling resistance coefficient. In yet another example, the loose ground traction control setting profile 642 could correspond to a <=60% friction coefficient and a 4%-10% rolling resistance coefficient. If the traction control guidance system 126 determines that the friction coefficient and rolling resistance coefficient of the loose ground traction control setting profiles 642 best corresponds to the friction data 402, the traction control guidance system 126 can use the traction control settings 648 corresponding to the loose ground traction control setting profile 642 to provide the guided traction control setting recommendation 408 to the display 200 to be presented to the user/driver.

With continuing reference to FIG. 6C, the first traction control setting for the sand traction control setting sub-profile 644 of the loose ground traction control setting profile 642 is high slope and/or heavy load. The second traction control setting for the sand traction control setting sub-profile 644 of the loose ground traction control setting profile 642 is high slope and/or heavy load. The third traction control setting for the sand traction control setting sub-profile 644 of the loose ground traction control setting profile 642 is. For the first instance of a determined fit between the friction data 402 and the sand traction control setting sub-profile 644, the traction control guidance system 126 will generate the first traction control setting shown in FIG. 6C (optitrack) as the guided traction control setting recommendation 408 to the display 200 to be presented to the user/driver. The traction control guidance system 126 will continue to receive the vehicle data 404 and determine the friction data 402 based on the received vehicle data 404. If the traction control guidance system 126 determines that its friction data 402 still indicates an insufficient traction for the vehicle 100, and the sand traction control setting sub-profile 644 is still determined to be the best fit of the friction data 402 to a traction control setting profile 406, the traction control guidance system 126 will then generate the second traction control setting in FIG. 6C (differential lock) as the guided traction control setting recommendation 408 to the display 200 to be presented to the user/driver as an additional traction control that will increase traction for the vehicle 100 if the user/driver had selected the first traction control setting. If the traction control guidance system 126 determines that its friction data 402 still indicates an insufficient traction for the vehicle 100, and the sand traction control setting sub-profile 644 is still determined to be the best fit of the friction data 402 to a traction control setting profile 406, the traction control guidance system 126 will then generate the third traction control setting in FIG. 6C (ASR off) as the guided traction control setting recommendation 408 to the display 200 to be presented to the user/driver as an additional traction control that will increase traction for the vehicle 100, if the user/driver had selected the second traction control setting. If at any time, the traction control guidance system 126 determines that its friction data 402 indicates a sufficient traction for the vehicle 100, and the sand traction control setting sub-profile 644 is still determined to be the best fit of the friction data 402 to a traction control setting profile 406, the traction control guidance system 126 will then reduce the traction control setting to the next lower traction control setting 648 as the guided traction control setting recommendation 408 to the display 200 to be presented to the user/driver as an reduced traction control that will decrease traction for the vehicle 100. This process continues in a repeated manner.

If the traction control guidance system 126 determines the loose ground traction control setting profile 642 is not determined to be the best fit of the friction data 402 to a traction control setting profile 406, the traction control guidance system 126 will use a different traction control setting profile 406 to provided the guided traction control setting recommendation 408 to the user/driver, including the traction control setting profile 406 in FIGS. 6A and 6B.

With continued reference to FIG. 6C, the loose ground traction control setting profile 642 also includes the wet earth road traction control setting sub-profile 646. In this example, the wet earth road traction control setting sub-profile 646 corresponds to a 55% friction coefficient and a 6% rolling resistance coefficient. If the traction control guidance system 126 determines that the friction coefficient and rolling resistance coefficient of the wet earth road traction control setting sub-profile 646 best corresponds to the friction data 402, the traction control guidance system 126 can use the traction control settings 648 corresponding to the wet earth road traction control setting sub-profile 646 to provide the guided traction control setting recommendation 408 to the display 200 to be presented to the user/driver. The first traction control setting for the wet earth road traction control setting sub-profile 646 is optitrack. The second traction control setting for the wet earth road traction control setting sub-profile 646 is differential lock. The third traction control setting for the wet earth road traction control setting sub-profile 646 is ASR off.

For the first instance of a determined fit between the friction data 402 and the wet earth road traction control setting sub-profile 646, the traction control guidance system 126 will generate the first traction control setting in FIG. 6C (optitrack) as the guided traction control setting recommendation 408 to the display 200 to be presented to the user/driver. The traction control guidance system 126 will continue to receive the vehicle data 404 and determine the friction data 402 based on the received vehicle data 404. If the traction control guidance system 126 determines that its friction data 402 still indicates an insufficient traction for the vehicle 100, and the wet earth road traction control setting sub-profile 646 is still determined to be the best fit of the friction data 402 to a traction control setting profile 406, the traction control guidance system 126 will then generate the second traction control setting in FIG. 6C (differential lock) as the guided traction control setting recommendation 408 to the display 200 to be presented to the user/driver as an additional traction control that will increase traction for the vehicle 100, if the user/driver had selected the first traction control setting. If the traction control guidance system 126 determines that its friction data 402 still indicates an insufficient traction for the vehicle 100, and the wet earth road traction control setting sub-profile 646 is still determined to be the best fit of the friction data 402 to a traction control setting profile 406, the traction control guidance system 126 will then generate the third traction control setting in FIG. 6C (ASR off) as the guided traction control setting recommendation 408 to the display 200 to be presented to the user/driver as an additional traction control that will increase traction for the vehicle 100, if the user/driver had selected the second traction control setting.

If at any time, the traction control guidance system 126 determines that its friction data 402 indicates a sufficient traction for the vehicle 100, and the wet earth road traction control setting sub-profile 646 is still determined to be the best fit of the friction data 402 to a traction control setting profile 406, the traction control guidance system 126 will then reduce the traction control setting to the next lower traction control setting 648 as the guided traction control setting recommendation 408 to the display 200 to be presented to the user/driver as an reduced traction control that will decrease traction for the vehicle 100. This process continues in a repeated manner.

Note that any of the percentages of the friction coefficient and/or rolling resistance coefficient can be changed for any of the traction control setting profiles in FIGS. 6A-6C can be programmed, altered, changed, or updated through programming. Also note that any of the traction control settings 612, 628, 648 for any of the traction control setting profiles in FIGS. 6A-6C can be programmed, altered, changed, or updated through programming.

As previously discussed, the traction control guidance system 126 can also be configured to provide a visual indication of the components of the vehicle 100 that are involved or engaged in any of the traction control settings activated in the GUI 202 displayed on the display 200 in FIG. 2. This provides another convenient method to display to a user/driver which components of the vehicle 100 are involved in providing traction control under control of the TCS 102, based on the traction control setting(s) activated by the user/driver through the GUI 202. As discussed above, the user/driver can select whatever traction control settings are desired to activate or de-activate through the GUI 202. These traction control settings can be accepted by the user/driver from guided traction control settings provided by traction control guidance system 126 as recommendations on the GUI 202 displayed on the display 200 to the user/driver.

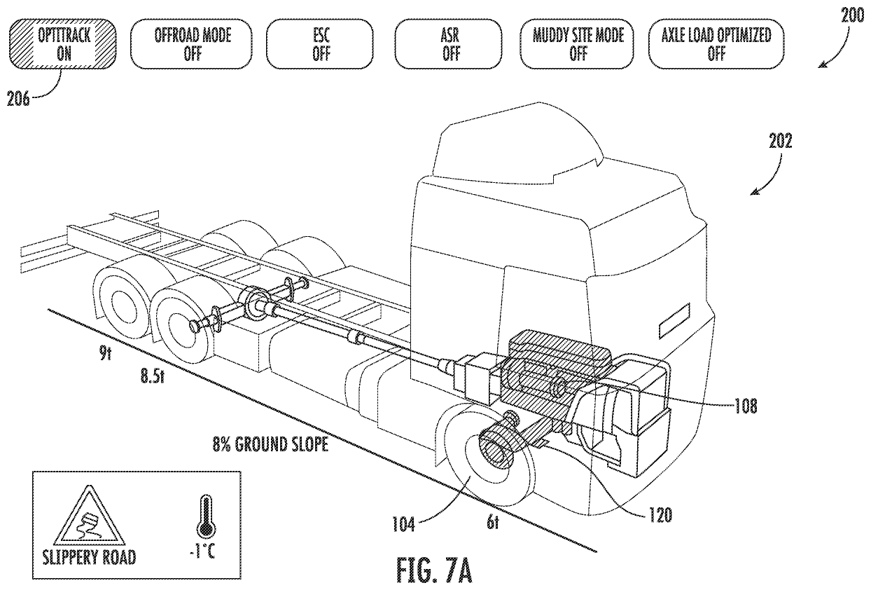

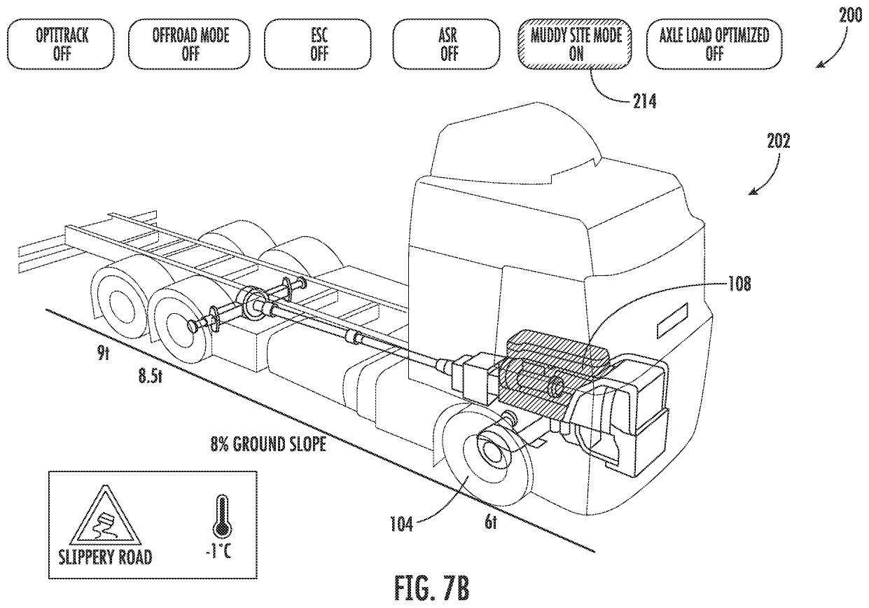

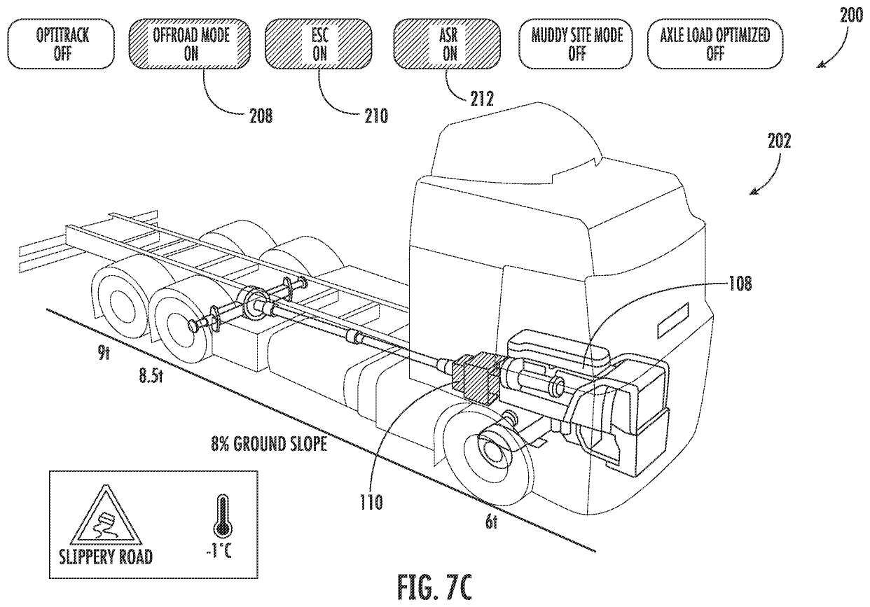

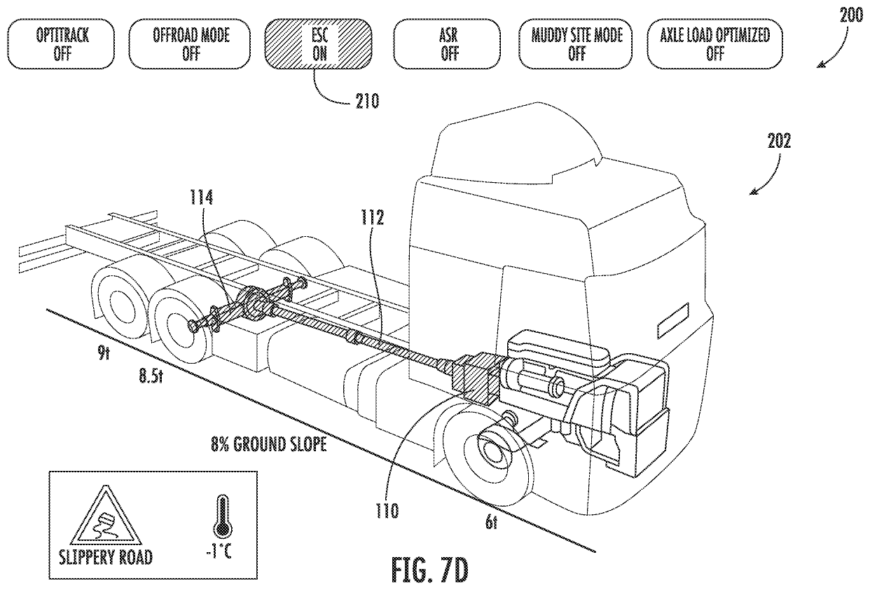

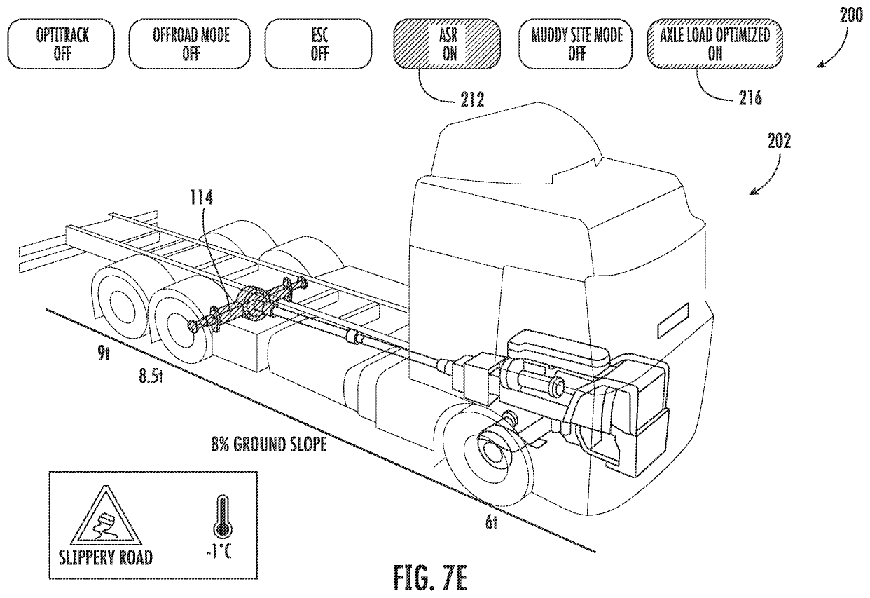

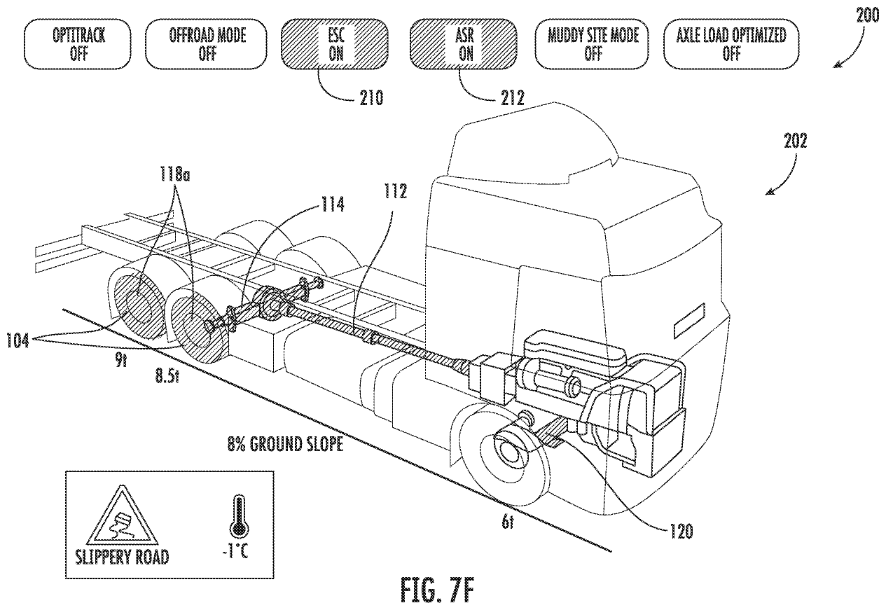

For example, FIG. 7A shows the GUI 202 generated by the traction control guidance system 126 in FIG. 3 and displayed on the display 200 in FIG. 2 to visually indicate the optitrack traction control setting is activated as a traction control setting. The optitrack visual traction control button 206 is generated by the traction control guidance system 126 to indicate textual status as ON as well as being highlighted to show its activation. In addition, the engine 108, the front axle 120, and the front tires 124 are highlighted in the GUI 202 by the traction control guidance system 126 to visually indicate to the user/driver that these vehicle components are involved in providing the optitrack traction control.

As another example, FIG. 7B shows the GUI 202 generated by the traction control guidance system 126 in FIG. 3 and displayed on the display 200 in FIG. 2 to visually indicate the muddy site traction control setting activated as a traction control setting. The muddy site visual traction control button 214 is generated by the traction control guidance system 126 to indicate textual status as ON as well as being highlighted to show its activation. In addition, the engine 108 is highlighted in the GUI 202 by the traction control guidance system 126 to visually indicate to the user/driver that this vehicle component is involved in providing the muddy site traction control.

As another example, FIG. 7C shows the GUI 202 generated by the traction control guidance system 126 in FIG. 3 and displayed on the display 200 in FIG. 2 to visually indicate the offroad mode traction control setting is activated as traction control setting. The offroad mode visual traction control button 208 is generated by the traction control guidance system 126 to indicate textual status as ON as well as being highlighted to show its activation. In addition, the gearbox 110 is highlighted in the GUI 202 by the traction control guidance system 126 to visually indicate to the user/driver that this vehicle component is involved in providing the offroad mode traction control.

As another example, FIG. 7D shows the GUI 202 generated by the traction control guidance system 126 in FIG. 3 and displayed on the display 200 in FIG. 2 to visually indicate the ASR traction control setting is activated as traction control setting. The ASR visual traction control button 212 is generated by the traction control guidance system 126 to indicate textual status as OFF.

As another example, FIG. 7E shows the GUI 202 generated by the traction control guidance system 126 in FIG. 3 and displayed on the display 200 in FIG. 2 to visually indicate the axle load optimization traction control setting is activated as traction control setting. The axle load optimization visual traction control button 216 is generated by the traction control guidance system 126 to indicate textual status as ON as well as being highlighted to show its activation. In addition, the rear axle 114 is highlighted in the GUI 202 by the traction control guidance system 126 to visually indicate to the user/driver that these vehicle components are involved in providing the axle load optimization traction control.

As another example, FIG. 7F shows the GUI 202 generated by the traction control guidance system 126 in FIG. 3 and displayed on the display 200 in FIG. 2 to visually indicate the differential lock control setting is activated as traction control setting. The differential lock is visually shown by the ESC visual traction control button 210 and the ASR visual traction control button 212 generated by the traction control guidance system 126 to indicate textual statuses as ON as well as being highlighted to show its activation. In addition, the front axle 120, the drive shaft 112, the rear axle 114, the wheels 118, and rear tires 104 are highlighted in the GUI 202 by the traction control guidance system 126 to visually indicate to the user/driver that these vehicle components are involved in providing the offroad mode traction control.

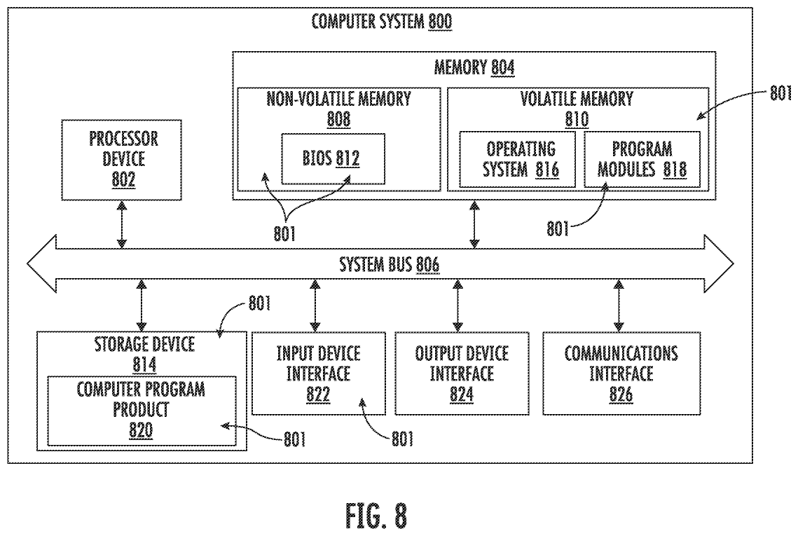

FIG. 8 is a schematic diagram of a computer system 800 for implementing examples disclosed herein, including the traction control guidance system 126. The computer system 800 may also be used for implementing the TCS 102 and/or the display 200. The computer system 800 is adapted to execute instructions from a computer-readable medium to perform these and/or any of the functions or processing described herein. The computer system 800 may be connected (e.g., networked) to other machines in a LAN, an intranet, an extranet, or the Internet. While only a single device is illustrated, the computer system 800 may include any collection of devices that individually or jointly execute a set (or multiple sets) of instructions to perform any one or more of the methodologies discussed herein.

The computer system 800 may comprise any computing or electronic device capable of including firmware, hardware, and/or executing programming instructions 801 (e.g., software instructions, firmware instructions) to implement the functionality described herein. The programming instructions 801 can be stored as non-transitory programming instructions on computer-readable medium. The computer system 800 includes a processor device 802 (may also be referred to as a control unit), a memory 804, and a system bus 806. The system bus 806 provides an interface for system components including, but not limited to, the memory 804 and the processor device 802. The processor device 802 may include any number of hardware components for conducting data or signal processing or for executing computer code, including the programming instructions 801, stored in memory 804. The processor device 802 (i.e., control unit) may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processor device may further include computer executable code that controls operation of the programmable device.

The system bus 806 may be any of several types of bus structures that may further interconnect to a memory bus (with or without a memory controller), a peripheral bus, and/or a local bus using any of a variety of bus architectures. The memory 804 may be one or more devices for storing data and/or computer code for completing or facilitating methods described herein. The memory 804 may include database components, object code components, script components, or other types of information structure for supporting the various activities herein. Any distributed or local memory device may be utilized with the systems and methods of this description. The memory 804 may be communicably connected to the processor device 802 (e.g., via a circuit or any other wired, wireless, or network connection) and may include computer code for executing one or more processes described herein. The memory 804 may include non-volatile memory 808 (e.g., read-only memory (ROM), erasable programmable read-only memory (EPROM), electrically erasable programmable read-only memory (EEPROM), etc.), and volatile memory 810 (e.g., random-access memory (RAM)), or any other medium which can be used to carry or store desired program code in the form of machine-executable instructions or data structures and which can be accessed by a computer or other machine with a processor device 802. The programming instructions 801 can be stored in non-volatile memory 808 and/or volatile memory 810. A basic input/output system (BIOS) 812 may be stored in the non-volatile memory 808 and can include the basic routines that help to transfer information between elements within the computer system 800. The programming instructions 801 can be stored in the BIOS 812.

The computer system 800 may further include or be coupled to a non-transitory computer-readable storage medium such as the storage device 814, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 814 and other drives associated with computer-readable media and computer-usable media may provide non-volatile storage of data, data structures, computer-executable instructions, and the like. The programming instructions 801 can be stored in storage device 814.

A number of modules can be stored in the storage device 814 and in the volatile memory 810, including an operating system 816 and one or more program modules 818, which may implement the functionality described herein in whole or in part. All or a portion of the examples disclosed herein may be implemented as a computer program product 820 (which includes the programming instructions 801) stored on a transitory or non-transitory computer-usable or computer-readable storage medium (i.e., single medium or multiple media), such as the storage device 814, which includes complex programming instructions, such as complex computer-readable program code, to cause the processor device 802 to carry out the steps described herein. Thus, the computer-readable program code can comprise software instructions for implementing the functionality of the examples described herein when executed by the processor device 802. The processor device 802 may serve as a controller, or control system, for the computer system 800 that is to implement the functionality described herein.

The computer system 800 also may include an input device interface 822 (e.g., input device interface and/or output device interface). The input device interface 822 may be configured to receive input (including the programming instruction 801) and selections to be communicated to the computer system 800 when executing instructions, such as from a keyboard, mouse, touch-sensitive surface, etc. Such input devices may be connected to the processor device 802 through the input device interface 822 coupled to the system bus 806 but can be connected through other interfaces such as a parallel port, an Institute of Electrical and Electronic Engineers (IEEE) 1394 serial port, a Universal Serial Bus (USB) port, an IR interface, and the like. The computer system 800 may include an output device interface 824 configured to forward output, such as to a display, a video display unit (e.g., a liquid crystal display (LCD) or a cathode ray tube (CRT)). The computer system 800 may also include a communications interface 826 suitable for communicating with a network as appropriate or desired.

The operational steps described in any of the exemplary embodiments herein are described to provide examples and discussion. The steps may be performed by hardware components, may be embodied in machine-executable instructions to cause a processor to perform the steps, or may be performed by a combination of hardware and software. Although a specific order of method steps may be shown or described, the order of the steps may differ. In addition, two or more steps may be performed concurrently or with partial concurrence.

It is to be understood that the present invention is not limited to the embodiments described above and illustrated in the drawings; rather, the skilled person will recognize that many changes and modifications may be made within the scope of the present disclosure and appended claims.

Implementation examples are also described in the following numbered clauses:
1. A method, comprising:
   receiving, by a processor of at least one computing device, friction data relating to at least one friction condition experienced by a vehicle;
   comparing, by the processor, the received friction data to at least one traction control setting profile each comprising one or more traction control settings;
   determining, by the processor, a recommended traction control setting profile of the at least one traction control setting profile corresponding to the received friction data; and
   communicating, by the processor, a recommended at least one traction control setting of the one or more traction control settings for the recommended traction control setting profile to a display, to be displayed.
2. The method according to clause 1, wherein the friction data comprises a rolling resistance of the vehicle.
3. The method according to clause 2, wherein the rolling resistance of the vehicle is based on at least one of amount of deformation of a wheel of the vehicle, an amount of deformation of a road surface, and an amount movement below the road surface.
4. The method according to any of clauses 1-3, wherein the friction data comprises a friction coefficient relating to friction of the vehicle.
5. The method according to any of clauses 1-4, wherein the friction data comprises a type of ground that the vehicle is disposed on.
6. The method according to any of clauses 1-5, further comprising:
   receiving, by the processor, an activation selection of the recommended at least one traction control setting; and
   causing, by the processor, the activation selection of the recommended at least one traction control setting to be activated as a traction control setting for the vehicle.
7. The method according to any of clause 6, further comprising:
   communicating, by the processor, an activation status of the selected recommended at least one traction control setting to the display to be displayed; and
   communicating, by the processor, an activation status for the selected recommended at least one traction control settings to the display to be displayed as a visual indicator on at least one traction control button on a graphical user interface (GUI) displayed on the display.
8. The method according to any of clauses 6-7, further comprising:
   receiving, by the processor, a deactivation selection of the recommended at least one traction control setting; and
   causing, by the processor, the deactivation selection of the recommended at least one traction control setting to be deactivated as a traction control setting for the vehicle.
9. The method according to clause 8, further comprising:
   communicating, by the processor, a deactivation status of the deactivated selection of the at least one traction control setting to the display to be displayed; and
   communicating, by the processor, a deactivation status for the deactivated selection of the at least one traction control settings to the display to be displayed, as a visual indicator on at least one traction control button on a graphical user interface (GUI) displayed on the display.
10. The method according to any of clauses 6-9, further comprising:
   receiving, by the processor, an activation selection of a second traction control setting not included in the recommended at least one traction control setting; and
   causing, by the processor, the second traction control setting selected to be activated as a traction control setting for the vehicle;
   communicating, by the processor, an activation status of the second one traction control setting to the display to be displayed; and
   communicating, by the processor, an activation status of the second traction control setting to the display to be displayed, as a visual indicator on a traction control button on a graphical user interface (GUI) displayed on the display.
11. The method according to any of clauses 1-10, comprising:
   comparing, by the processor, the received friction data to a plurality of traction control setting profiles each comprising one or more traction control settings; and
   determining, by the processor, the recommended traction control setting profile of the plurality of traction control setting profile corresponding to the received friction data based on the best fit of the friction data to a traction control setting profile of the plurality of traction control settings.
12. The method according to clause 11, further comprising:
   receiving, by the processor, second friction data relating to at least one friction condition experienced by the vehicle;
   comparing, by the processor, the received second friction data to the plurality of traction control setting profiles; and
   determining, by the processor, if the second friction data has a better fit to a different traction control setting profile of the plurality of traction control setting profiles than the recommended traction control setting profile; and
   in response to the processor determining the second friction data has a better fit to a different traction control setting profile than the recommended traction control setting profile, communicating, by the processor, a second recommended at least one traction control setting of the one or more traction control settings for the different traction control setting profile to the display, to be displayed.
13. The method according to any of clauses 1-12, further comprising:
   receiving, by the processor, second friction data relating to at least one friction condition experienced by the vehicle;
   determining, by the processor, if the second friction data indicates a sufficient traction for the vehicle; and
   in response to determining the second friction data indicates an insufficient traction for the vehicle, communicating, by the processor, a second recommended traction control setting of the recommended traction control setting profile to the display, to be displayed.
14. The method according to clause 13, further comprising:
   receiving, by the processor, an activation selection of the second recommended traction control setting; and
   causing, by the processor, the second recommended traction control setting selected to be activated as a second traction control setting for the vehicle.
15. The method according to any of clauses 13-14, further comprising:
   receiving, by the processor, second friction data relating to at least one friction condition experienced by the vehicle;
   determining, by the processor, if the second friction data indicates a sufficient traction for the vehicle; and
   in response to determining the second friction data indicates a sufficient traction for the vehicle, communicating, by the processor, the recommended at least one traction control setting to be deactivated to the display, to be displayed.
16. The method according to clause 15, further comprising:
   receiving, by the processor, a deactivation selection of the recommended at least one traction control setting; and
   causing, by the processor, the recommended at least one traction control setting selected to be deactivated as a traction control setting for the vehicle.
17. The method according to any of clauses 1-16, wherein the at least one traction control setting comprises a plurality of traction control settings comprising optitrack, muddy site, offroad mode, anti-slip regulation (ASR) off, axle load optimization, and differential lock.
18. The method according to any of clauses 1-17, wherein:
   the at least one traction control setting profile comprises a hard ground traction control setting profile comprising at least one of (1) a ≥75% friction coefficient and a ≤2% rolling resistance coefficient; (2) a ≥62% friction coefficient and a 3-6% rolling resistance coefficient; and (3) a 30%-55% friction coefficient and a ≤2% rolling resistance coefficient, and at least one hard ground traction control setting comprised from the group consisting of offroad mode, optitrack, and differential lock; and
   comprising:
      determining, by the processor, a recommended traction control setting profile of the hard ground traction control setting profile corresponding to the received friction data; and
      communicating, by the processor, the at least one hard ground traction control setting as the recommended traction control setting profile to the display, to be displayed.
19. The method according to any of clauses 1-17, wherein:
   the at least one traction control setting profile comprises a hard ground traction control setting profile comprising a 55%-65% friction coefficient and a ≤3% rolling resistance coefficient; and at least one loose ground traction control setting comprised from the group consisting of muddy site, optitrack, differential lock, offroad mode, and anti-slip regulation (ASR) off; and
   comprising:
      determining, by the processor, a recommended traction control setting profile of the loose ground traction control setting profile corresponding to the received friction data; and
      communicating, by the processor, the at least one loose ground traction control setting as the recommended traction control setting profile to the display, to be displayed.
20. The method according to any of clauses 1-17, wherein:
   the at least one traction control setting profile comprises at least one hard ground traction control setting profile comprising a ≤15% friction coefficient and a ≤2% rolling resistance coefficient; and at least one loose ground traction control setting comprised from the group consisting of axles load optimization, optitrack, and differential lock; and
   comprising:
      determining, by the processor, a recommended traction control setting profile of the hard ground traction control setting profile corresponding to the received friction data; and
      communicating, by the processor, the at least one hard ground traction control setting as the recommended traction control setting profile to the display, to be displayed.
21. The method according to any of clauses 1-17, wherein:
   the at least one traction control setting profile comprises a hard ground traction control setting profile comprising a 15%-30]% friction coefficient and a ≤2% rolling resistance coefficient; and at least one loose ground traction control setting comprised from the group consisting of axles load optimization, optitrack, differential lock, and anti-slip regulation (ASR) off; and
   comprising:
      determining, by the processor, a recommended traction control setting profile of the loose ground traction control setting profile corresponding to the received friction data; and
      communicating, by the processor, the at least one loose ground traction control setting as the recommended traction control setting profile to the display, to be displayed.
22. The method according to any of clauses 1-17, wherein:
   the at least one traction control setting profile comprises a hard ground traction control setting profile comprising at least one of (1) ≥50% friction coefficient and a ≥10% rolling resistance coefficient, and (2) <60% friction coefficient and a 4%-10]% rolling resistance coefficient; and at least one loose ground traction control setting comprised from the group consisting of optitrack, differential lock, and anti-slip regulation (ASR) off; and
   comprising:
      determining, by the processor, a recommended traction control setting profile of the loose ground traction control setting profile corresponding to the received friction data; and
      communicating, by the processor, the at least one loose ground traction control setting as the recommended traction control setting profile to the display, to be displayed.
23. A vehicle comprising a processor device configured to perform the method of clause 1.
24. A computer system, comprising:
   at least one computing device comprising a processor device configured to:
   receive friction data relating to at least one friction condition experienced by a vehicle;
   compare the received friction data to at least one traction control setting profile each comprising one or more traction control settings;
   determine a recommended traction control setting profile of the at least one traction control setting profile corresponding to the received friction data; and
   communicate a recommended at least one traction control setting of the one or more traction control settings for the recommended traction control setting profile to a display, to be displayed.

25. A non-transitory computer-readable storage medium comprising programming instructions, which, when executed by a processor device of a computing system, cause the processor device to:
receive friction data relating to at least one friction condition experienced by a vehicle;
compare the received friction data to at least one traction control setting profile each comprising one or more traction control settings;
determine a recommended traction control setting profile of the at least one traction control setting profile corresponding to the received friction data; and
communicate a recommended at least one traction control setting of the one or more traction control settings for the recommended traction control setting profile to a display, to be displayed.

What is claimed is:

1. A computer system, comprising:
at least one computing device comprising a processor device configured to:
receive friction data relating to at least one friction condition experienced by a vehicle;
compare the received friction data to at least one traction control setting profile each comprising one or more traction control settings;
determine a recommended traction control setting profile of the at least one traction control setting profile corresponding to the received friction data; and
communicate a recommended at least one traction control setting of the one or more traction control settings for the recommended traction control setting profile to a display, to be displayed.

2. The computer system of claim 1, wherein the friction data comprises a rolling resistance of the vehicle.

3. The computer system of claim 2, wherein the rolling resistance of the vehicle is based on at least one of amount of deformation of a wheel of the vehicle, an amount of deformation of a road surface, and an amount movement below the road surface.

4. The computer system of claim 1, wherein the friction data comprises a friction coefficient relating to friction of the vehicle.

5. The computer system of claim 1, wherein the friction data comprises a type of ground that the vehicle is disposed on.

6. The computer system of claim 1, wherein the processor device is further configured to:
receive an activation selection of the recommended at least one traction control setting; and
cause the activation selection of the recommended at least one traction control setting to be activated as a traction control setting for the vehicle.

7. The computer system of claim 6, wherein the processor device is further configured to:
communicate an activation status of the selected recommended at least one traction control setting to the display to be displayed; and
communicate an activation status for the selected recommended at least one traction control settings to the display to be displayed as a visual indicator on at least one traction control button on a graphical user interface (GUI) displayed on the display.

8. The computer system of claim 6, wherein the processor device is further configured to:
receive a deactivation selection of the recommended at least one traction control setting; and
cause the deactivation selection of the recommended at least one traction control setting to be deactivated as a traction control setting for the vehicle.

9. The computer system of claim 8, wherein the processor device is further configured to:
communicate a deactivation status of the deactivated selection of the at least one traction control setting to the display to be displayed; and
communicate a deactivation status for the deactivated selection of the at least one traction control settings to the display to be displayed, as a visual indicator on at least one traction control button on a graphical user interface (GUI) displayed on the display.

10. The computer system of claim 6, wherein the processor device is further configured to:
receive an activation selection of a second traction control setting not included in the recommended at least one traction control setting; and
cause the second traction control setting selected to be activated as a traction control setting for the vehicle;
communicate an activation status of the second one traction control setting to the display to be displayed; and
communicate an activation status of the second traction control setting to the display to be displayed, as a visual indicator on a traction control button on a graphical user interface (GUI) displayed on the display.

11. The computer system of claim 1, wherein the processor device is configured to:
compare the received friction data to a plurality of traction control setting profiles each comprising one or more traction control settings; and
determine the recommended traction control setting profile of the plurality of traction control setting profile corresponding to the received friction data based on the best fit of the friction data to a traction control setting profile of the plurality of traction control settings.

12. The computer system of claim 11, wherein the processor device is further configured to:
receive second friction data relating to at least one friction condition experienced by the vehicle;
compare the received second friction data to the plurality of traction control setting profiles; and
determine if the second friction data has a better fit to a different traction control setting profile of the plurality of traction control setting profiles than the recommended traction control setting profile; and
communicate a second recommended at least one traction control setting of the one or more traction control settings for the different traction control setting profile to the display to be displayed, in response to the processor determining the second friction data has a better fit to a different traction control setting profile than the recommended traction control setting profile.

13. The computer system of claim 1, wherein the processor device is further configured to:
receive second friction data relating to at least one friction condition experienced by the vehicle;
determine if the second friction data indicates a sufficient traction for the vehicle; and
communicate a second recommended traction control setting of the recommended traction control setting profile to the display to be displayed, in response to determining the second friction data indicates an insufficient traction for the vehicle.

14. The computer system of claim 13, wherein the processor device is further configured to:
receive second friction data relating to at least one friction condition experienced by the vehicle;
determine if the second friction data indicates a sufficient traction for the vehicle; and
communicate the recommended at least one traction control setting to be deactivated to the display to be displayed, in response to determining the second friction data indicates a sufficient traction for the vehicle.

15. The computer system of claim 1, wherein the at least one traction control setting comprises a plurality of traction control settings comprising optitrack, muddy site, offroad mode, anti-slip regulation (ASR) off, axle load optimization, and differential lock.

16. A method, comprising:
receiving, by a processor of at least one computing device, friction data relating to at least one friction condition experienced by a vehicle;
comparing, by the processor, the received friction data to at least one traction control setting profile each comprising one or more traction control settings;
determining, by the processor, a recommended traction control setting profile of the at least one traction control setting profile corresponding to the received friction data; and
communicating, by the processor, a recommended at least one traction control setting of the one or more traction control settings for the recommended traction control setting profile to a display, to be displayed.

17. The method of claim 16, further comprising:
receiving, by the processor, an activation selection of the recommended at least one traction control setting; and
causing, by the processor, the activation selection of the recommended at least one traction control setting to be activated as a traction control setting for the vehicle.

18. The method of claim 17, further comprising:
communicating, by the processor, an activation status of the selected recommended at least one traction control setting to the display to be displayed; and
communicating, by the processor, an activation status for the selected recommended at least one traction control settings to the display to be displayed as a visual indicator on at least one traction control button on a graphical user interface (GUI) displayed on the display.

19. A vehicle comprising a processor device configured to perform the method of claim 16.

20. A non-transitory computer-readable storage medium comprising programming instructions, which, when executed by a processor device of a computing system, cause the processor device to:
receive friction data relating to at least one friction condition experienced by a vehicle;
compare the received friction data to at least one traction control setting profile each comprising one or more traction control settings;
determine a recommended traction control setting profile of the at least one traction control setting profile corresponding to the received friction data; and
communicate a recommended at least one traction control setting of the one or more traction control settings for the recommended traction control setting profile to a display, to be displayed.
